(19) United States
(12) Patent Application Publication
(10) Pub. No.: US 2013/0206072 A1
(43) Pub. Date: Aug. 15, 2013

(54) ISLAND FOR ANIMAL CAGE

(71) Applicant: UNIVERSITY OF CONNECTICUT, (US)

(72) Inventors: Cathy COGSWELL, Tolland, CT (US); Trudy DUFRESNE, Ashford, CT (US); Michail KASTELLORIZIOS, Willington, CT (US); Lisa M. ROBERTS, Union, CT (US); Carl STOELZEL, Stafford Springs, CT (US); Janet TROMBLEY, Canterbury, CT (US)

(73) Assignee: UNIVERSITY OF CONNECTICUT, Farmington, CT (US)

(21) Appl. No.: 13/766,316

(22) Filed: Feb. 13, 2013

Related U.S. Application Data
(60) Provisional application No. 61/598,491, filed on Feb. 14, 2012.

(51) Int. Cl. A01K 1/035; A01K 29/00

(52) U.S. Cl. CPC A01K 1/035; A01K 29/00
USPC 119/28.5

(57) ABSTRACT

The present disclosure provides for a device having a pair of parallel walls; and a plurality of steps disposed between the pair of parallel walls. Each of the plurality of steps has a run that spans a space to connect the pair of parallel walls and a rise having an opening that opens to the space. The present disclosure provides for an enrichment device for use in an animal cage in which the device is a hollow structure with four vertical walls. The device includes a plurality of steps that span a hollow space between the four vertical walls. Each of the plurality of steps has a rise that is opened to a hollow space between the four vertical walls and a run.

### CROSS-REFERENCE TO RELATED APPLICATION

This application is related to, and claims priority in, U.S. Provisional Patent Application No. 61/598,491 filed on Feb. 14, 2012, the disclosure of which is incorporated in its entirety by reference herein.

### BACKGROUND OF THE DISCLOSURE

1. Field of the Disclosure

This disclosure relates to an enrichment device that is able support an animal or animals above water in a cage.

2. Description of Related Art

Currently, there exist various types of cage furniture or enrichment devices for animals in cages. Certain enrichment devices are designed to protect animals from the effects of water or flooding in the cage. Such enrichments devices are suspended from the top of a cage for an animal to jump and seek refuge from cold bedding or water. While such devices may work well in certain environments or cages, those devices may not be suitable for all cages. Cages may be too small to accommodate a suspended enrichment device or may be constructed in such a manner that suspending the device from an upper surface of the cage is not possible.

Other devices are designed as shelters and would not necessarily prevent drowning or hypothermia resulting from flooding or wet bedding.

Accordingly, there is a need for an enrichment device for an animal that is designed to keep an animal, such as a mouse or a rat, away from water in the cage in the event of a flood and for a device that is also an exercise device for the animal.

### SUMMARY OF THE DISCLOSURE

The present disclosure provides for an enrichment device for a caged animal (or animals) that is able to support the animal or be a surface to which the animal may climb to escape water during a flood in the cage.

The present disclosure also provides for an enrichment device that has a plurality of steps or surfaces that are above the floor of a cage in which such device is installed.

The present disclosure further provides for an enrichment device that has a plurality of steps or surfaces and openings between such steps or surfaces to permit animals to climb on such steps or surfaces or crawl through openings on such device.

The present disclosure still further provides for an enrichment device that occupies a minimal foot print on the floor of a cage and will not use valuable area for the animals.

The present disclosure still further provides for an enrichment device that is able to protect animals from floods in a cage by providing elevated surfaces or steps for such animals and to simultaneously be an entertainment, exercise or sheltering device for the animals.

The present disclosure provides for a device having a pair of parallel walls; and a plurality of steps disposed between the pair of parallel walls. Each of the plurality of steps has a run that spans a space to connect the pair of parallel walls and a rise having an opening that opens to the space.

The present disclosure provides for an enrichment device for an animal cage having a hollow structure with four vertical walls. The device includes a plurality of steps that span a hollow space between the four vertical walls. Each of the plurality of steps has a rise that is opened to a hollow space between the four vertical walls and a run.

### BRIEF DESCRIPTION OF THE DRAWINGS

FIG. 1 illustrates a perspective view of the enrichment device according to the present disclosure;

FIG. 2 illustrates a front view of the device of FIG. 1, according to the present disclosure;

FIG. 3 illustrates a side view of the device according to the present disclosure; and

FIG. 4 illustrates the enrichment device of FIG. 1 installed in a cage.

### DETAILED DESCRIPTION OF THE PREFERRED EMBODIMENT OF THE DISCLOSURE

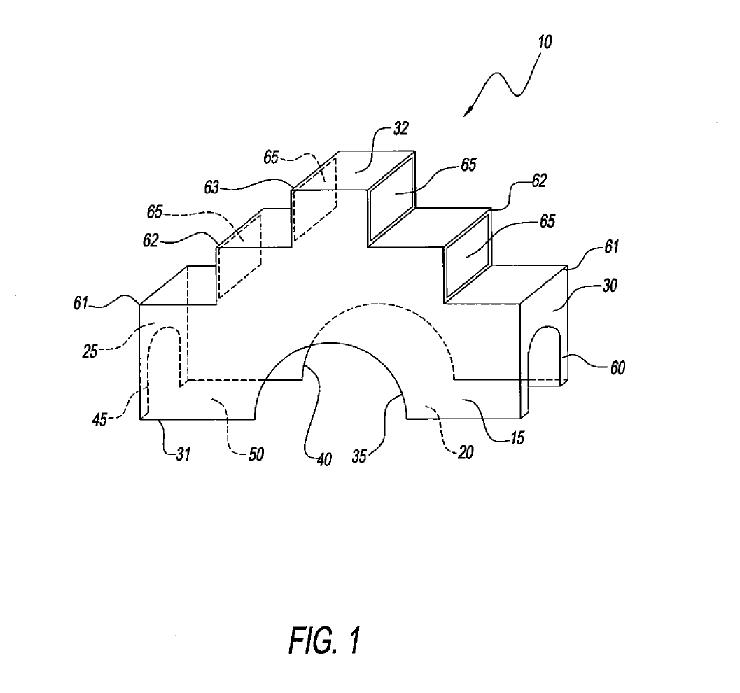

Referring to FIG. 1, a drawing of the enrichment device (device) according to the present disclosure, shown and referenced by reference numeral 10. Device 10 is has two step-shaped opposed walls 15 and 20. Device 10 has two arched walls 25 and 30. Walls 15 and 20 are spaced apart and parallel to each other. Walls 25 and 30 are spaced apart and parallel to each another. Walls 15 and 20 are connected to walls 25 and 30 such that adjacent walls 15 and 25 and 20 and 30 are joined at 90° angles to form a free standing hollow structure. Accordingly, device 10 has a hollow interior space 50 and a lower surface 31 that rests on the floor of a cage in which such device 10 is placed. Surface 31 includes bottom edges of walls 15, 20, 45 and 60 and does not have a bottom surface that connects the bottom edges of such walls.

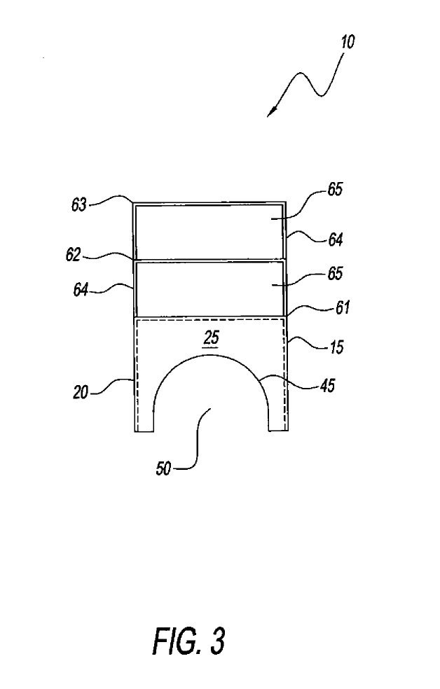

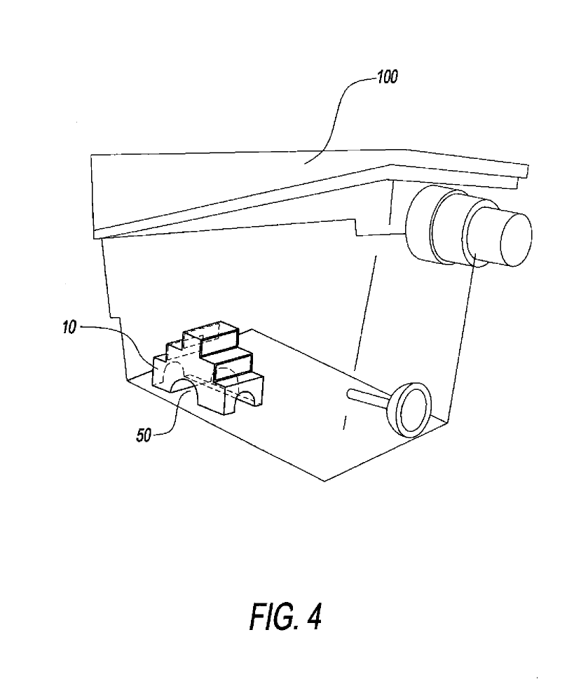

Referring to FIGS. 1 and 3, walls 15 and 20 each has an opening 35 and 40, respectively. Walls 25 and 30 each has an opening 45 and 60, respectively. Openings 35, 40, 45 and 60 allow animals to have access to interior 50 when device 10 is placed in a cage 100 as shown in FIG. 4. While openings 35, 40, 45 and 60 are shown as being arch shaped or semi-circular, such openings may have other shapes.

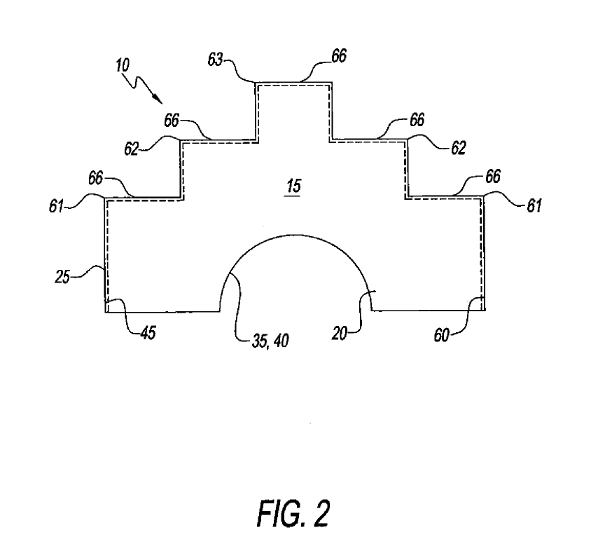

Referring to FIGS. 1 and 2, walls 15 and 20 and walls 45 and 60 are connected together to form a plurality of steps, specifically first steps 61, second steps 62 and a third step 63 between second steps 62. Second steps 62 and third step 63 each has a rise 64 and a run 66. Each run 66 spans interior 50 and connects walls 15 and 20. Each run 66 is a flat surface or flat level on which an animal may climb, rest, sleep, play or eat. Each rise 64 of steps 62 and 63 is opened to provide openings 65. Openings 65 provide access to and egress from interior 50 in the same fashion as openings 35, 40, 45, and 60. First steps 61 have walls 25 and 30 that function as rises. Device 10 has steps 61, 62, and 63 that provide a plurality of steps or levels on which an animal may climb to escape flooding or wet bedding in a cage.

Device 10 can be used for caged animals of different sizes, such as mice or rats. Accordingly, device 10 may have more steps to accommodate larger animals. Walls 15 and 20 can be approximately five inches in length or longer. Openings 35 and 40 each has a radius of approximately one inch. Walls 25 and 30 are about 1.5 inches in height and have a width of about two inches. Openings 45 and 60 are about 1.5 in wide and one inch high. Openings 35, 40, 45 and 60 are centrally located on each wall 15, 20, 20 and 25, respectively. The dimensions of the openings 35, 40, 45 and 60 may be made larger to accommodate animals larger than mice.

Each of the plurality of steps, namely first steps 61, second steps 62 and top step 63, has a depth of about one inch to provide an animal or animals surfaces on which they may rest for a length of time. Significantly, each of the plurality of steps is sized to permit a mouse or mice to rest for an extended period of time to escape a cage flood or wet bedding. Openings 65 are each about 0.75 inches high and two inches wide to permit animals to climb through, stretch through or extend their noses through. Openings 65 may be sized to accommodate animals of different sizes. Plurality of steps enables animals to climb and explore cage 100. Plurality of steps can be used for exercise and entertainment. Device 10 has a height of about 3.5 inches from lower surface 31 to upper surface 32 or top of step 63, as shown in FIG. 1. Device 10 enables an animal to reach from upper surface 32 of step 63 to observe different parts of container 100 from an elevation.

Device 10 is preferably constructed from plastic or any other resilient material that is able to be exposed to water and animals for extended periods of time.

Referring to FIGS. 1 and 4, device 10 is hollow and lower surface 31 occupies a minimal amount of surface of floor of cage 100. Accordingly, device 10 will not crowd or confine animals in cage 100 because such device 10 is bottomless and does not have a solid base.

It should be understood that the foregoing description is only illustrative of the present disclosure. Various alternatives and modifications can be devices by those skilled in the art without departing from the disclosure. Accordingly, the present disclosure is intended to embrace all such alternatives, modification and variances that fall within the scope of the present disclosure.

We claim:

1. A device comprising:
a pair of parallel walls; and
a plurality of steps disposed between said pair of parallel walls;
wherein each of said plurality of steps comprises a run that spans a space to connect said pair of parallel walls and a rise having an opening that opens to the space.

2. The device of claim 1, further comprising a second pair of parallel walls, wherein adjacent walls of said pair of parallel walls and said second pair of parallel walls connect at an angle of 90° and enclose the space.

3. The device of claim 1, wherein each of said pair of parallel walls contains an opening to provide access to and egress from the space.

4. The device of claim 1, wherein each of said pair of parallel walls each has a stepped shape.

5. The device of claim 2, wherein each of said second pair of parallel walls each comprises an opening.

6. The device of claim 5, wherein said opening in said second pair of parallel walls is an arch shaped opening.

7. The device of claim 1, wherein said pair of parallel walls each has a length of about 5 inches.

8. The device of claim 1, wherein said opening is sized to accommodate one or more small animals.

9. The device of claim 8, wherein said animal is one of a mouse or a rat.

10. An enrichment device for use in an animal cage, the device comprising:
a hollow structure having four vertical walls;
a plurality of steps that span a hollow space between said four walls, wherein each of said plurality of steps comprises a rise that is opened to a hollow space between said four vertical walls and a run.

11. The device of claim 10, wherein adjacent walls of each of said four vertical walls connect at an angle of 90° and enclose the hollow space.

12. The device of claim 10, wherein each of said four vertical walls comprises an opening to provide access to the hollow space.

13. The device of claim 12, wherein said opening in each of said four vertical walls is sized to accommodate a small animal.

14. The device of claim 13, wherein said animal is one of a mouse or a rat.

15. The device of claim 10, wherein said hollow structure is bottomless.
